(19) United States
(12) Patent Application Publication
(10) Pub. No.: US 2011/0162378 A1
(43) Pub. Date: Jul. 7, 2011

(54) TUNABLE TRANSITION PIECE AFT FRAME

(75) Inventors: RONALD JAMES CHILA, GREER, SC (US); WEI CHEN, GREER, SC (US); GREGORY A. BOARDMAN, GREER, SC (US)

(73) Assignee: GENERAL ELECTRIC COMPANY, SCHENECTADY, NY (US)

(21) Appl. No.: 12/652,904

(22) Filed: Jan. 6, 2010

(51) Int. Cl. F02C 7/141

(52) U.S. Cl. 60/752

(57) ABSTRACT

A tunable transition piece aft-frame is disclosed for tuning the exit profile of combustion products as such products flow from a transition piece to a combustion product receiving apparatus. The aft-frame includes a generally rectilinear shaped body which has a laterally extending flange. Dilution holes are formed in the flange and are configured to allow dilution air to penetrate into the flow of the combustion products to shape the exit temperature profile of the combustion products.

### FIELD OF THE INVENTION

The subject matter disclosed herein relates generally to combustion systems and particularly to a combustion assembly for flowing combustion products between a combustor and a combustion product receiving apparatus. More particularly, the subject matter relates to a tunable transition piece aft-frame having dilution holes to facilitate tuning of the exit temperature profile of combustion products.

### BACKGROUND OF THE INVENTION

In a conventional gas turbine, numerous combustors are disposed around an annular array about the axis of the machine. A compressor supplies compressed air to each combustor, wherein the compressed air and fuel are mixed and burned. Hot gases of combustion flow from each combustor through a transition piece to a first stage nozzle to drive the turbine and generate power. An aft-frame is typically attached to the downstream or aft end of the transition piece and generally includes a sealing element to prevent leakage of the hot gases at the interface between the transition piece and the first stage nozzle.

A combustion system in a gas turbine is sometimes installed with predetermined dilution flow hole areas used for injecting dilution air, deriving from a portion of the compressor discharge air, into the hot gas flow. Such dilution air is used to reduce the production of air pollution emissions, such as oxides of nitrogen and carbon monoxide, and to shape the gas temperature profile of the combustion products. A desirable gas temperature profile, for example, provides improved hot gas path durability, increased turbine component life and improved turbine performance.

Dilution flow hole areas are generally installed in combustor liners or transition pieces, as is shown in U.S. Pat. No. 4,944,149 (Kuwata) and U.S. Pat. No. 7,373,772 (Simons et al). As such, the gas temperature profile of the combustion products is typically shaped upstream from the point at which the combustion products exit the combustion system and enter the first stage nozzle of a turbine. Unfortunately, the tailored gas temperature profile may change prior to entering the nozzle due to the turbulent nature of the combustion products or due to various other factors. Accordingly, there is a need for a system and apparatus to account for such changes.

Moreover, it is not uncommon for the hot gas temperature profile to become somewhat compromised after a turbine has been in operation for a period of time. This can be due to, for example, varied operating conditions or wear on the components of the combustion system. In such circumstances, it may be desirable to alter or tune the dilution flow areas to adjust the quantity and orientation of the dilution air flowing into the combustion products. However, this can be a costly and time consuming process, especially when major components of the combustor, such as the combustor liner and the transition piece, must be removed. Thus, there is a need for a system and apparatus that offers efficiency and flexibility in altering or tuning the hot gas temperature profile, particularly the ability to tailor the profile to an individual application.

### BRIEF DESCRIPTION OF THE INVENTION

Aspects and advantages of the present subject matter will be set forth in part in the following description, or may be obvious from the description, or may be learned through practice of the present subject matter.

In one aspect, the present subject matter provides a tunable transition piece aft-frame for tuning the hot gas temperature profile of combustion products exiting a transition piece. The tunable transition piece aft-frame comprises a body and a plurality of dilution holes. The body is generally rectilinear shaped and comprises an inner surface, an outer surface and a laterally extending flange. The flange is configured to be attached to the transition piece. Dilution holes are formed in the flange and are configured to allow dilution air from the compressor to penetrate into the flow of the combustion products to tune the temperature profile of the hot gases.

In another aspect, the present subject matter also encompasses a unique combustion assembly located between a combustor and a combustion product receiving apparatus. The combustion assembly includes a transition piece and an aft-frame. The transition piece comprises an enclosure defining a flowpath for combustion products. The enclosure has a forward end and an aft end, the forward end being configured for receiving combustion products from the combustor. The aft-frame is attached to the aft end of the transition piece and is configured such that the combustion products flowing from the transition piece pass through the aft-frame and into the combustion product receiving apparatus. Dilution holes are formed in the aft-frame and allow dilution air from the compressor to penetrate into the flow of the combustion products and shape the temperature profile of the hot gases.

These and other features, aspects and advantages of the present subject matter will become better understood with reference to the following description and appended claims. The accompanying drawings, which are incorporated in and constitute a part of this specification, illustrate embodiments of the present subject matter and, together with the description, serve to explain the principles of the present subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 provides a cross-sectional view of a combustion system;

FIG. 2 provides a perspective view of a of an embodiment of the tunable transition piece aft-frame in accordance with an aspect of the present subject matter;

FIG. 3 provides a sectional view of an embodiment of the tunable transition piece aft-frame in accordance with an aspect of the present subject matter;

FIG. 4 provides a cross-sectional view of an embodiment of a combustion assembly in accordance with an aspect of the present subject matter; and

FIG. 5 provides a detailed, cross-sectional view of an embodiment of a combustion assembly in accordance with an aspect of the present subject matter.

### DETAILED DESCRIPTION OF THE INVENTION

Reference now will be made in detail to embodiments of the present subject matter, one or more examples of which are illustrated in the drawings. Each example is provided by way of explanation and not limitation of the present subject matter. In fact, it will be apparent to those skilled in the art that various modifications and variations can be made in the present subject matter without departing from the scope or spirit of the present subject matter. For instance, features illustrated or described as part of one embodiment, can be used with another embodiment to yield a still further embodiment. Thus, it is intended that the present subject matter covers such modifications and variations as come within the scope of the appended claims and their equivalents.

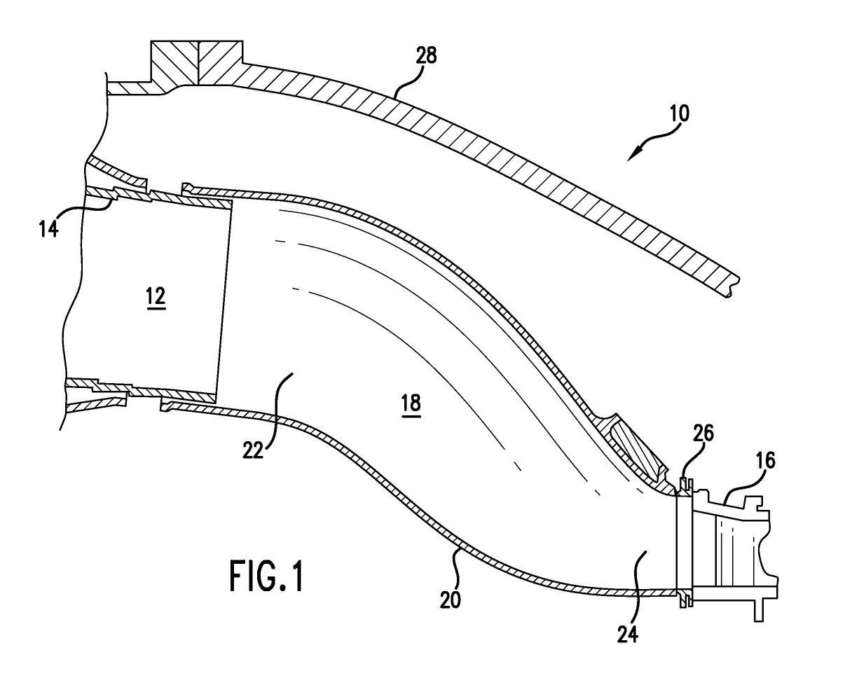

A cross-sectional view of a combustion system 10 is illustrated, for example, in FIG. 1. Components of the system 10 include a transition piece 18 for enclosing and confining combustion products for flow from a combustor 12 of a gas turbine to a first stage nozzle 16. It should be appreciated that there is an annular array of combustors for generating and flowing hot gases to an annular array of nozzles 16, one of each of such combustors 12, nozzles 16 and transition pieces 18 being illustrated. Also illustrated is a portion of the compressor discharge casing 28. Compressor discharge air is typically provided within the space between the casing 28 and the combustor liner 14 and transition piece 18 to cool combustion system components and as a source of dilution air.

As shown in FIG. 1, the transition piece 18 includes an enclosure 20 for confining and directing the flow of combustion products from the combustor 12 to the nozzle 16. Thus, the enclosure 20 includes a forward end 22 and an aft end 24 for respectively receiving the combustion products and flowing the combustion products in the direction of the nozzle 16. The forward end 22 of the transition piece 18 is generally circular. In one embodiment, the transition piece 18 may transition from a circular forward end 22 generally axially and radially inwardly relative to the turbine axis and terminates in a slightly arcuate, generally rectilinear aft end 24. Located between the aft end 24 and the nozzle 16 is a typical aft-frame 26. The aft-frame 26 may be generally rectilinear in shape to match the shape of the aft end 24 of the transition piece 18 and is typically attached to the transition piece 18 by welding the aft-frame 26 to the aft end 24.

As is generally understood in the art, a percentage of the compressor discharge air is used as dilution air, flowing through dilution flow hole areas (not illustrated) in, for example, the combustor liner 14 or transition piece 18, to shape the temperature profile of the combustion products. In addition to or as an alternative to such dilution flow hole areas, a tunable transition piece aft-frame 30, such as is disclosed in the present subject matter and described in greater detail below, can be installed into the combustion system 10 to properly shape the gas temperature profile of the combustion products exiting the combustion system. This can improve hot gas path durability and thereby improve performance of the turbine via a reduction in the cooling air needed to sufficiently cool turbine components during operation. It should be appreciated, however, by those of ordinary skill in the art that the tunable transition piece aft-frame 30 disclosed herein can be used to shape the exit profile of combustion products flowing into any combustion product receiving apparatus or device. The first stage nozzle 16, described above, is only intended as an example and should not be construed as limiting the application of the present subject matter to gas turbines.

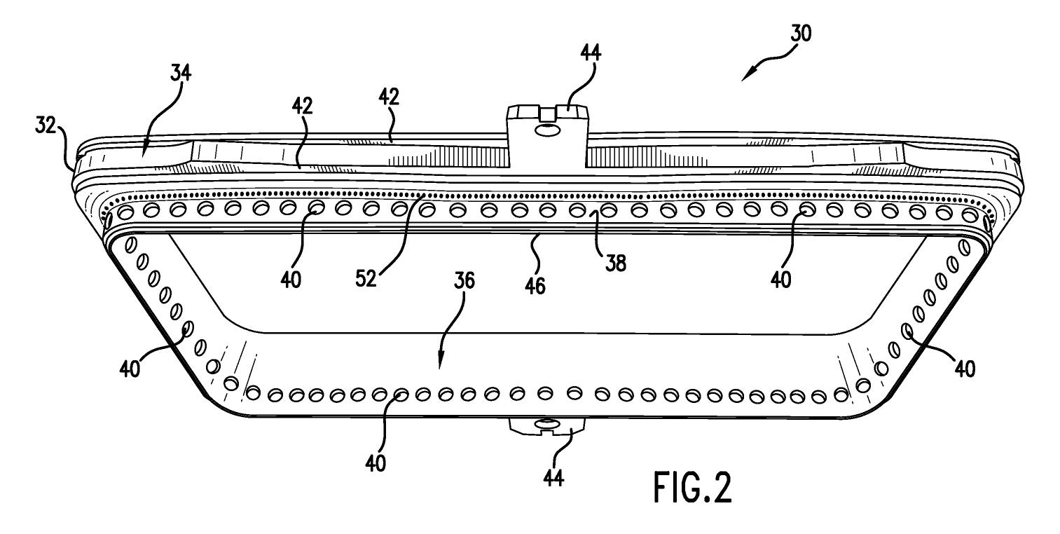

Referring to FIG. 2, an embodiment of a tunable transition piece aft-frame 30 in accordance with an aspect of the present subject matter is illustrated. The aft-frame 30 includes a body 32 that is generally rectilinear in shape. It should be readily appreciated, however, that the body 32 can have any desired shape and need not have the particular shape illustrated in FIG. 2. For instance, the aft-frame may be circular, be in the shape of an oval or be in the shape of any suitable polygon. The shape of the aft-frame 30 will depend in large part on the particular shape and configuration of the transition piece 18.

The body 32 includes an outer surface 34 and an inner surface 36. The outer surface 34 may include parallel grooves 42 which extend around the perimeter of the outer surface 34. Such grooves can be, for example, configured to receive a sealing element (riot illustrated) to prevent leakage of the combustion products as they flow from the transition piece 18 to a combustion product receiving apparatus, such as the first stage nozzle 16. The outer surface 34 may also include at least one mounting hook 44 extending generally outward from the outer surface 34. The mounting hook 44 may be configured to secure the aft-frame 30 to any combustion product receiving apparatus or device. Aft-frame cooling holes 52 can also be located on the outer surface, as discussed in greater detail below.

The body 32 also includes a laterally extending flange 38, The flange 38 is configured such that the aft-frame 30 may be attached to a transition piece 18 of a combustion system. The aft-frame 30, for example, may be welded to the transition piece 18. In such an embodiment, an outer lip 46 of the flange 38 may be configured such that flange 38 can be welded to the aft end 24 of the transition piece 18. Additionally, the flange 38 may generally have any length and thickness. In one embodiment, the maximum flange length is 5.1 cm and the flange thickness ranges from 0.3 cm to 0.65 cm, such as from 0.4 to 0.6 and all other subranges therebetween,

Additionally, dilution holes 40 are formed in the flange 38 of the tunable transition piece aft-frame 30. The dilution holes 40 are configured to allow dilution air to enter the flow of the combustion products and penetrate the hot gas flow. Since the dilution air is cooler than the combustion products flowing through the transition piece 18, the dilution air can significantly alter the temperature profile of the combustion products exiting the combustion system.

The dilution holes 40 can be any shape or size, can have any suitable depth, can be arranged in any manner, and can be distributed in any way. For example, the dilution holes 40 may be circular and have diameters ranging from 0.2 cm to 1.3 cm, such as from 0.5 cm to 1.2 cm and all other subranges therebetween. The dilution holes 40 may also have a pitch spacing that ranges from 0.5 to 2.0 times the dilution hole diameter, such as from 1.2 to 1.5 times the dilution hole diameter and all other subranges therebetween. Moreover, any number of dilution holes 40 may be formed in the aft-frame 30. In one embodiment of the aft-frame 30, the total count of dilution holes 40 may range from 50 to 300 holes, such as from 100 to 280 holes and all other subranges therebetween.

Furthermore, as illustrated in FIG. 2, the dilution holes 40 may be of equal area such that substantially identical quantities of the dilution air enter the flow of the combustion products through each dilution hole 40. Conversely, the dilution holes 40 could have varying areas to allow different quantities of dilution air to flow into the combustion products at particular locations around the aft-frame 30. Additionally, the dilution holes 40 may be spaced apart equally on the flange 38 or may be spaced along the flange 38 randomly or at varying distances.

It should be readily apparent that the sizes, shapes, and configurations of the dilution holes 40 will be chosen depending upon the desired or prescribed gas temperature profile for any particular application. For example, in one application the desired profile of the combustion products may be spatially uniform. In another, it may be preferable to have a radially non-uniform profile wherein the combustion products are coolest near the inner surface 36 of the aft-frame 30 and hottest near a centerline of the combustion products. Such a radially non-uniform temperature profile may be beneficial, for example, as applied in a gas turbine since the circumferentially extending platforms at the radial extremities of the first stage turbine vanes are inherently more difficult to cool than the airfoil that extends radially between the platforms.

In addition to offering the ability to properly shape the exit profile of combustion products flowing through a new combustion system, the tunable transition piece aft-frame 30 of the present subject matter can be quickly and efficiently installed into an existing combustion system in order to appropriately tune the gas temperature profile and achieve a desired hot gas path durability. For example, the aft-frame 30 could be installed into an existing system in which the hot gas path durability has been compromised. In doing so, the operating conditions of the system, including combustor output temperatures and the like, may be analyzed to determine an appropriate dilution hole 40 configuration, size, and shape to effectively tune the exit profile of the existing combustion system to improve its hot gas path durability and performance.

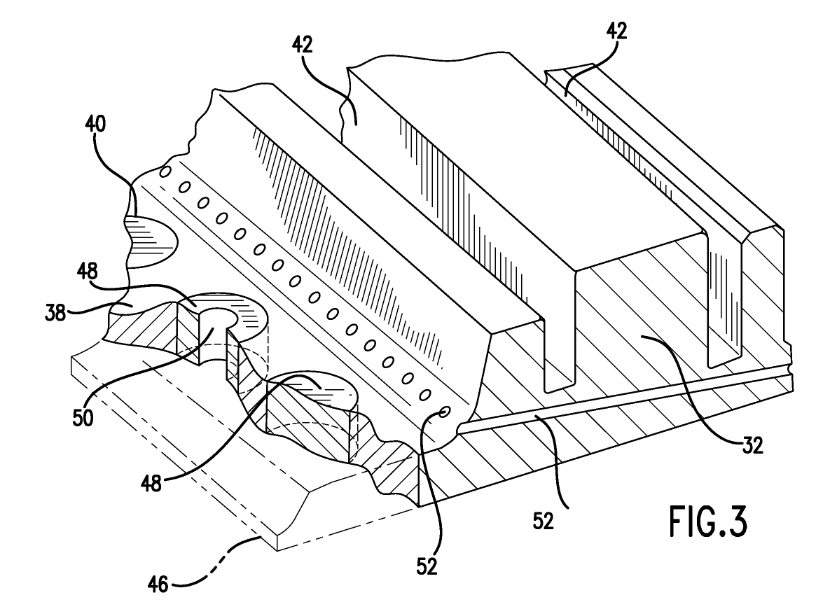

As illustrated in FIG. 3, the tunable transition piece aft-frame 30 may also include one or more dilution hole plugs 48 that can be utilized to adjust the amount of dilution air flowing through each dilution hole 40 to finely tune or alter the gas temperature profile, providing even more flexibility in tailoring the profile of the combustion products exiting the combustion system. For example, one, several, or all of the dilution holes 40 may be oversized; meaning that excess amounts of the compressor discharge air are entering the flow of the combustion products as dilution air. As shown in FIG. 3, the plug 48 may be configured to be inserted into a dilution hole 40 to partially or fully block the flow of dilution air through the dilution hole 40. For example, the plug 48 can fully encompass the dilution hole 40 to completely block the flow of dilution air. Conversely, the plug 48 can include an opening 50 that is dimensionally smaller than the dilution hole 40. The opening 50 may permit a reduced amount of dilution air to enter the flow of the combustion products. Thus, once a plug 48 is inserted into the dilution hole 40, the amount of dilution air flowing into the combustion products is slightly reduced, allowing the exit profile of the hot gases to be finely tuned. It should appreciated, however, that other embodiments of the dilution holes 40 can have adjustable sizes using any other suitable technique or method.

Referring to FIG. 2 and FIG. 3, the body 32 of the aft-frame 30 may also include a plurality of aft-frame cooling holes 52. The cooling holes 52 allow compressor discharge air to flow into and cool the body 32, and more particularly the inner surface 36. This may be used to improve, for example, the operating life of the aft-frame, as the inner surface 36 is constantly exposed to hot combustion products. It should be noted, however, that the primary function of the cooling holes 52 is to cool or quench the aft-frame 30, not to shape the hot gas temperature profile. Thus, the cooling holes 52 may be dimensionally smaller than the dilution holes 40 and designed to receive a smaller percentage of the compressor discharge air.

As shown in FIG. 3, the cooling holes 52 are located on the outer surface 34 of the body 32 near the flange 38 and extend at an angle from the outer surface 34 to the rear of the body 32. Nonetheless, it should be readily appreciated that the cooling holes 52 may be located at any position on the aft-frame 30 and have any configuration or orientation. For example, it may be desirable for the cooling holes 52 to extend at an angle from the outer surface 34 to the inner surface 36, allowing compressor discharge air to exit onto and directly cool the inner surface 36.

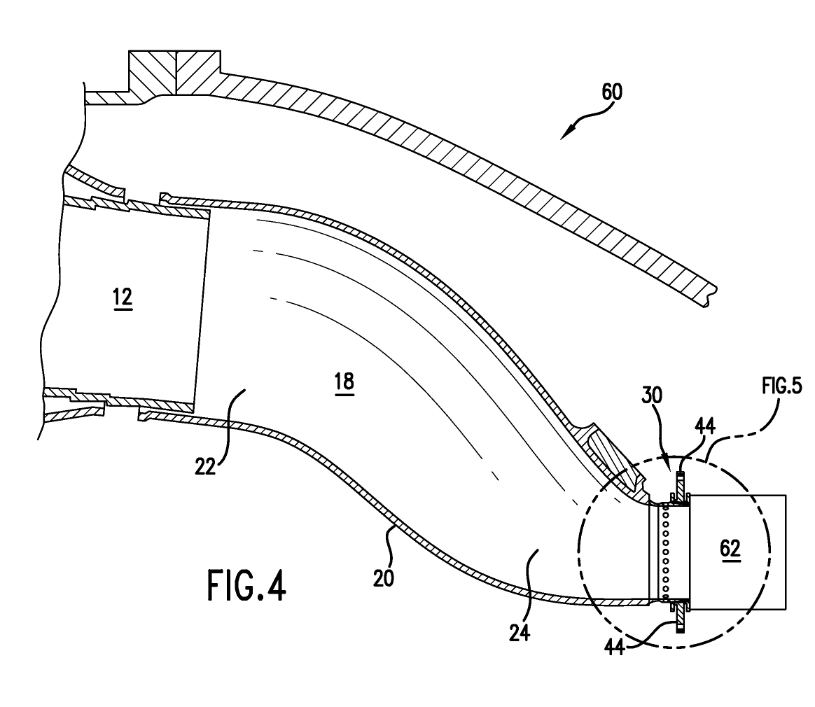

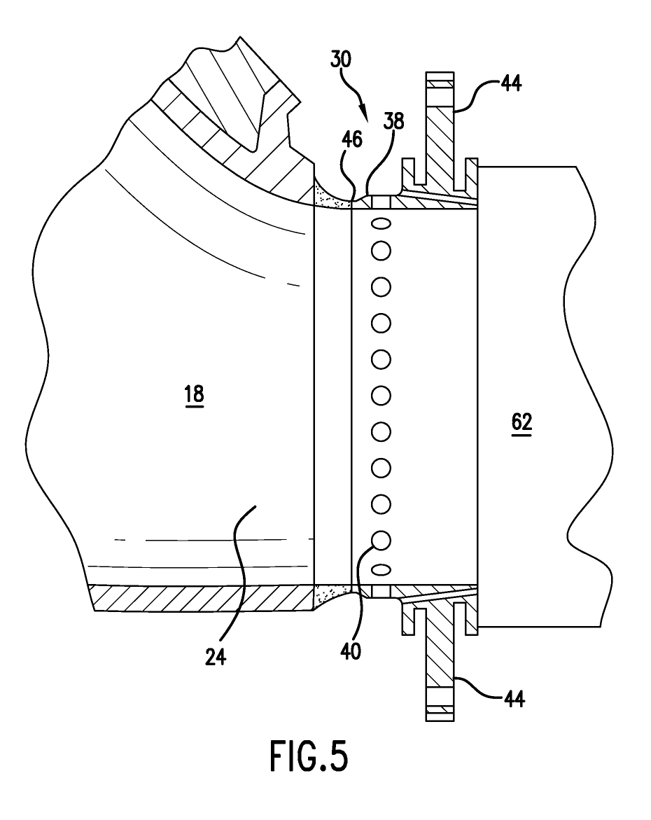

Referring to FIG. 4 and FIG. 5, it should be appreciated that the present subject matter also encompasses a combustion assembly 60, located between a combustor 12 and a combustion product receiving apparatus 62, which allows the exit temperature profile of combustion products flowing from the combustor 12 to be properly shaped or tuned. As illustrated, the combustion assembly 60 comprises a transition piece 18 as was generally described above. It should be appreciated that the combustion product receiving apparatus 62 may be any apparatus or device that is configured, adapted, or designed to receive combustion products flowing from a combustor including, but certainly not limited to, a first stage nozzle in a gas turbine.

The combustion assembly 60 also includes a tunable transition piece aft-frame 30 that is attached to the aft end 24 of the transition piece 18 and is configured such that combustion products flowing from the transition piece 18 pass through the aft-frame 30 and into the combustion product receiving apparatus 62. The aft-frame 30 may be attached to the transition piece 18 by any means. As illustrated, the aft-frame 30 is welded to the aft end 24 at the outer lip 46 of the flange 38. In addition, the aft-frame 30 may comprise other elements or may be further configured as is in accordance with any of the embodiments illustrated herein and described above.

A plurality of dilution holes 40 is formed in the aft-frame 30 and configured to allow dilution air to enter the flow of the combustion products to shape or tune the exit temperature profile. As explained above, the dilution holes 40 may have any size, shape or arrangement depending primarily on the desired exit profile of the combustion products and may be generally configured in accordance with any of the embodiments illustrated herein and described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A tunable transition piece aft-frame for tuning the exit profile of combustion products as such products flow from a transition piece to a combustion product receiving apparatus, comprising:
a generally rectilinear shaped body comprising an inner surface, an outer surface and a laterally extending flange; and
a plurality of dilution holes formed in said flange, wherein each of said plurality of dilution holes allows dilution air to penetrate into the flow of the combustion products to shape the exit temperature profile of the combustion products.

2. The tunable transition piece aft-frame of claim 1, wherein each of said plurality of dilution holes is of equal area such that substantially identical quantities of the dilution air penetrate into the flow of the combustion products through each of said plurality of dilution holes.

3. The tunable transition piece aft-frame of claim 1, wherein each of said plurality of dilution holes varies in area such that differing quantities of the dilution air penetrate into the flow of the combustion products through each of said plurality of dilution holes.

4. The tunable transition piece aft-flame of claim 1, further comprising at least one dilution hole plug configured to be inserted into any one of said plurality of dilution holes so that the flow of dilution air penetrating through any one of said plurality of dilution holes is blocked.

5. The tunable transition piece aft-frame of claim 4, wherein said at least one dilution hole plug only partially blocks the flow of dilution air, said at least one dilution hole plug comprising an opening configured to allow dilution air to penetrate into the flow of the combustion products.

6. The tunable transition piece aft-frame of claim 1, wherein each of said plurality of dilution holes is spaced apart equally along said flange.

7. The tunable transition piece aft-frame of claim 1, wherein each of said plurality of dilution holes is spaced apart in varying distances along said flange.

8. The tunable transition piece aft-frame of claim 1, said body further comprising a plurality of aft-frame cooling holes, wherein each of said plurality of aft-frame cooling holes is dimensionally smaller than any one of said plurality of dilution holes and is configured to allow compressor discharge air to flow into and cool said body.

9. A combustion assembly located between a combustor and a combustion product receiving apparatus, comprising:
a transition piece comprising an enclosure defining a flowpath and having a forward end and an aft end, said forward end configured for receiving combustion products from a combustor;
an aft-frame attached to said aft end and configured such that the combustion products flowing from said aft end pass through said aft-frame and into a combustion product receiving apparatus, said aft-frame comprising an inner surface and an outer surface; and
a plurality of dilution holes formed in said aft-frame, wherein each of said plurality of dilution holes allows dilution air to penetrate into the flow of the combustion products to shape the exit temperature profile of the combustion products.

10. The combustion assembly of claim 9, said aft-frame further comprising a laterally extending flange, wherein said plurality of dilution holes is located on said flange.

11. The combustion assembly of claim 9, wherein each of said plurality of dilution holes is of equal area such that substantially identical quantities of the dilution air penetrate into the flow of the combustion products through each of said plurality of dilution holes.

12. The combustion assembly of claim 9, wherein each of said plurality of dilution holes varies in area such that differing quantities of the dilution air penetrate into the flow of the combustion products through each of said plurality of dilution holes.

13. The combustion assembly of claim 9, further comprising at least one dilution hole plug configured to be inserted into any one of said plurality of dilution holes so that the flow of dilution air penetrating through any one of said plurality of dilution holes is blocked.

14. The combustion assembly of claim 13, wherein said at least one dilution hole plug only partially blocks the flow of dilution air, said at least one dilution hole plug comprising an opening configured to allow dilution air to penetrate into the flow of the combustion products.

15. The combustion assembly of claim 9, wherein each of said plurality of dilution holes is spaced apart equally along said aft-frame.

16. The combustion assembly of claim 9, wherein each of said plurality of dilution holes is spaced apart in varying distances along said aft-frame.

17. The combustion assembly of claim 9, said aft-frame further comprising a plurality of aft-frame cooling holes, wherein each of said plurality of aft-frame cooling holes is dimensionally smaller than any one of said plurality of dilution holes and is configured to allow compressor discharge air to flow into and cool said aft-frame.

18. The combustion assembly of claim 9, wherein said aft-frame is welded to said transition piece.
